(19) United States
(12) Patent Application Publication
(10) Pub. No.: US 2010/0003536 A1
(43) Pub. Date: Jan. 7, 2010

(54) METAL MATRIX COMPOSITE MATERIAL

(76) Inventors: George David William Smith, Oxford (GB); Patrick Spencer Grant, Oxford (GB); Marina Lorena Galano, Oxford (GB); Fernando Enrique Audebert, Buenos Aires (AR)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/446,900

(22) PCT Filed: Oct. 22, 2007
(86) PCT No.: PCT/GB2007/004004

§ 371 Date: Apr. 23, 2009

(30) Foreign Application Priority Data
Oct. 24, 2006 (GB) 0621073.6

(51) Int. Cl. B32B 5/22; B32B 5/16; B22F 1/00

(52) U.S. Cl. 428/608; 419/62

(57) ABSTRACT

According to the present invention there is provided a metal matrix composite material and a method for the manufacture thereof, the material comprising an aluminium-based alloy matrix, the matrix comprising a microstructure composed of at least a first aluminium alloy phase and having a second phase of nanostructured quasicrystalline particles embedded therein and further including in said matrix fibrils of at least one other dissimilar material.

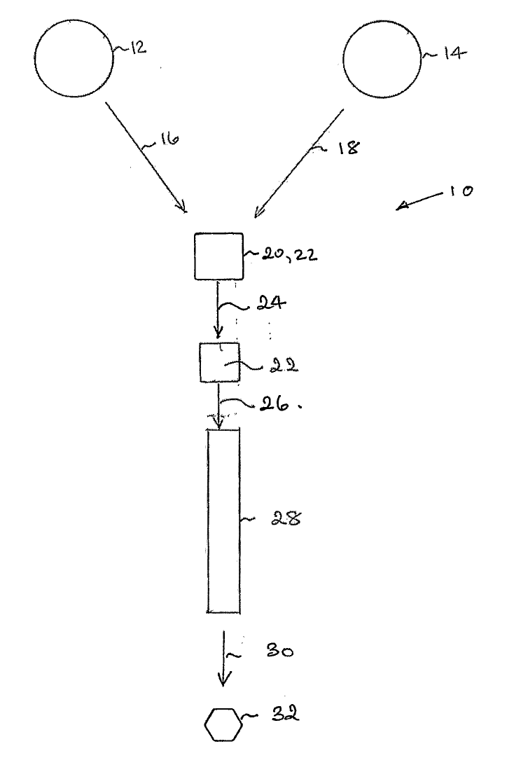

The present invention relates to an aluminium alloy matrix metal composite material and to methods of manufacturing the material.

### BACKGROUND

Metal composite materials having a metal matrix and a second reinforcing constituent incorporated therein are known in the prior art. An example of such a material is an aluminium matrix having titanium filaments incorporated therein. The material was produced by a powder metallurgy compaction route followed by mechanical working to densify and to produce a wrought material wherein the titanium content is ultimately rendered in the form of fibrils in the composite. One problem with such materials is that whilst they exhibit high room temperature strength, their strength at elevated temperatures is poor.

It is an object of the present invention to provide composite materials and methods for the production thereof which have high strength together with good ductility and/or high toughness and high stiffness over a broad temperature range.

### BRIEF SUMMARY OF THE DISCLOSURE

According to a first aspect of the present invention there is provided a metal matrix composite material, the material comprising an aluminium-based alloy matrix, the matrix comprising a microstructure composed of at least a first aluminium alloy phase and having a second phase of nanostructured quasicrystalline particles embedded therein and further including in said matrix fibrils of at least one other dissimilar material.

Thus, the composite material according to the first aspect of the present invention comprises an aluminium-based alloy matrix having reinforcing fibrils of at least one other dissimilar material therein, the aluminium-based alloy matrix itself comprising a plurality of constituent phases including nanostructured quasicrystalline particles in the matrix.

For the avoidance of doubt, a “nanostructured quasicrystalline” phase may be regarded as comprising quasicrystals of nanoscale dimensions. The “quasi” portion of the term refers to the fact that quasicrystals in many aspects resemble conventional crystals, but differ from these in one important aspect: that they are not built by a single unit cell which repeats periodically in space. The structure of quasicrystals comprises of atoms that are arranged in a non-periodic fashion, showing long-range order, but no translational periodicity at least in one direction. “Nano” is derived from the nanoscale dimensions of the quasicrystals, and in this specification is defined as a size less than 1 μm. However, it must be borne in mind that the total number of nanostructured quasicrystalline particles within the aluminium alloy matrix are predominantly less than 1 μm in size but that there may exist a small proportion of quasicrystalline particles which exceed this dimension. In simplistic terms the nanoquasicrystalline phase may be regarded as a solid with conventional crystalline properties but exhibiting a point group symmetry inconsistent with translational symmetry.

It is preferred that the nanostructured quasicrystalline particle phase in the aluminium-based alloy matrix may be in the form of icosahedral particles distributed throughout the matrix. Strictly speaking, an “icosahedral particle” is a three-dimensional non-periodical phase with 2, 3 and 5-fold axes of rotational symmetry, which can be found as an icosahedral polyhedron having twenty faces. However, for the purpose of this patent specification other quasicrystalline particles in addition to those having perfect icosahedral symmetry are also to be understood as being included within this definition. Such quasicrystalline particles may also include, for example, a decagonal phase and imperfect forms related to these “geometrically perfect” forms and aggregated forms including sub-units of such kinds of particles. Quasicrystals are known to exhibit decagonal symmetry in many cases and this may be manifested in the final shape of the nanostructured particles embedded in the matrix. Thus, the term “icosahedral” is to be understood as encompassing a wide range of different polygonal particles, both perfect and imperfect in form.

Whilst the matrix and quasicrystalline embedded phases of the aluminium-based alloy and their preferred features have been defined hereinabove it is entirely possible owing to the complex metallurgical nature of the alloys under consideration that the matrix may contain further unspecified phases which may or may not conform to the definitions given hereinabove.

Examples of aluminium-based alloys which may form the matrix of the composite materials according to the first aspect of the present invention include, but are not limited to: Al—Fe; Al—Ni; Al—Mn; Al—Cr; Al—V; Al—V—Ni; Al—Ni—Co; Al—Cu—Fe; Al—Fe—V; Al—Fe—Ti; Al—Fe—Mn; Al—Mn—Co; Al—Mn—Ni; Al—Mn—Ce (or MM); Al—Cr—Ce (or MM); Al—Cu—Fe—Cr; Al—Fe—Nb; Al—Fe—Ce; Al—Fe—Cr; Al—Fe—Cr—X (where X includes one or more elements selected from the group comprising Si, Ce, Ti, V, Nb and Ta, and MM is mischmetal, a mixture of rare earth elements). It is stressed that this list of example aluminium alloy matrices is exemplary only and that many other possible systems may exist; the important feature is that the matrix alloy should comprise at least the two phases defined hereinabove, i.e. at least the first matrix phase and the second, nanostructured quasicrystalline phase.

In the case of one of the preferred matrix alloys, the Al—Fe—Cr—X system, it is known that the addition of chromium to the basic Al—Fe system enhances the formation of second phase nanoquasicrystalline icosahedral particles in the matrix. As noted above, icosahedral particles may be defined as a quasicrystalline phase with no translational periodicity. The icosahedral structure possesses an extended orientational order, that is having full rotational symmetry, but lacks translational symmetry. The icosahedral particles provide a strengthening phase to the surrounding aluminium-based alloy matrix tending to give retention of strength to the alloy at elevated temperatures, i.e. at temperatures at which conventional high-strength, structural aluminium alloys would weaken by, for example, grain coarsening, precipitation of strengthening phases (over-aging) and other mechanisms. The basic Al—Fe—Cr alloy having a nominal composition of, in atomic % (as are subsequent examples), Al93-Fe4.2-Cr2.8, retains its icosahedral strengthening phase at temperatures up to about 350° C. but extended heating at this temperature causes the icosahedral particles to degrade by diffusion thereby reducing the strength. Addition of titanium to the alloy to form a nominal composition of Al93-Fe3-Cr2-Ti2 causes the icosahedral structure of the reinforcing particles to be retained at least up to temperatures of about 400° C. at which temperature it begins to degrade upon prolonged heating. However, addition of niobium to the basic alloy to give a composition of Al93-Fe3-Cr2-Nb2 provides an alloy in which the icosahedral nanostructured quasicrystalline particle structure is retained at least to temperatures of about 500° C. and above, indeed, this beneficial structure appears to be retained even to the onset of melting.

Whilst specific alloy compositions have been given in the preceding paragraph, the matrix alloys of the composite materials according to the present invention are not so limited.

Taking the Al—Fe—Cr—X system as an example, the aluminium content should desirably be in the range from 88 to 96 at % but more preferably in the range from 90 to 95 at %. The X component, where X may be selected from one or more of titanium, vanadium, niobium, tantalum and silicon, should not exceed 4 at % in total but, more preferably, should not exceed 3 at %. The contents of the iron and chromium constituents may be selected in order to avoid the formation of large, brittle intermetallic particles such as, for example, Al₁₃Fe₄ or AlFe, which are brittle phases and deleterious to the ductility and toughness of the resulting alloy. Furthermore, where there is an excess of iron, the formation of Al₁₃Fe₃ as needle-shaped particles can be promoted and which is also deleterious to ductility. Also, where chromium content is greater than iron content, the quasicrystalline phase can be formed but the precipitation of other intermetallic compounds with the X element may be promoted and a higher quenching rate may be required to achieve the desired nanostructured quasicrystalline phase. It is also known that an excess of silicon can promote the formation of Al—Si—Fe phases instead of the required nanostructured quasicrystalline phase. Therefore, it will be apparent to those people skilled in the art that it is not possible to lay down arbitrary constituent limits and ranges due to the large number of inter-related variables involved.

The fibrillar constituent is defined hereinabove as “at least one other dissimilar material”. Thus it is envisaged that the fibrillar constituent may comprise metallic and/or non-metallic materials.

In the case of metals the fibrillar constituent may in principle comprise any suitable dissimilar metal or alloy, the metal or alloy desirably having a melting point above either that temperature at which the matrix alloy is combined with the fibril material or a melting point above that temperature at which the composite material is subsequently worked by mechanical deformation.

Where enhanced ductility of the resulting composite material is desired, then the fibrillar constituent may preferably comprise a ductile metal or alloy.

It should be noted that the material from which the fibrillar constituent may be formed may not be in fibrillar form at the stage when it is combined with the aluminium-based alloy matrix material but may be converted into a fibrillar constituent during subsequent working of the base composite material. There may be unsuitable ductile metals or alloys but this will depend to a great extent on the nature of the matrix alloy and whether or not there is any rapid and/or extensive inter-diffusion effects between the aluminium-based alloy matrix material and the fibril metal during processing of the base composite material to its final form, wherein such diffusion effects produce undesirable phases such as brittle phases, for example. However, the mere existence of inter-diffusion between the interfaces of the matrix and fibrillar material is not necessarily harmful and indeed may be beneficial in terms of bonding and internal strengthening.

Examples of material for forming the fibrils may include nickel, molybdenum, titanium, niobium, tantalum, vanadium and chromium and suitable alloys thereof. However, this list may not be exhaustive and other metals may be suitable. In principle, metals having an adverse effect with the aluminium matrix metal such as, for example, by forming harmful, brittle intermetallic phases or compounds therewith during heat treatment, for example, should in general be avoided. An example of this may be iron fibrils which are likely to form an intermetallic phase with the aluminium matrix metal such as, for example, one or more of those discussed above. However, fibrils of iron-containing alloys may be acceptable in that the iron may be trapped in the fibril alloy and not available for harmful intermetallic phase formation. Thus the use of iron, for example, in the fibril material may be acceptable depending on the precise circumstances. The same reasoning applies to other strong metals which may, prima-facie, appear unsuitable.

In addition to metallic fibrils discussed above it is further envisaged that some non-metallic materials may also be useful as a reinforcing medium in the aluminium alloy matrix. Examples of such materials may include carbon nanotubes or nanofibrils, boron nitride fibres, tubes or whiskers.

Whilst it is accepted that such non-metallic materials lack ductility, they are extremely strong and possess a very high Young's Modulus. Therefore, such materials whilst not tending to improve the ductility of the composite material according to the present invention may make such composite materials very strong with inter alia a very high stiffness. Indeed, the incorporation of carbon nanotubes, for example, may produce a material having a significantly increased Young's modulus which would be a very valuable property especially in the aviation industry.

The composite material according to the present invention may contain from about 5 to about 50 volume % of the reinforcing fibril material

In a preferred embodiment of the composite material according to the first aspect of the present invention the fibril constituent may be in the form of nanofibrils or nanotubes wherein the diameter of said fibrils or tubes may be less than 1 μm.

It will be appreciated that the composite material according to the present invention may comprise more than one fibrillar material and, furthermore, may comprise both metallic and non-metallic fibrillar material.

According to a second aspect of the present invention, there is provided a method for the production of a metal matrix composite material, the material comprising an aluminium-based alloy matrix comprising a microstructure having at least a first phase of aluminium-based alloy material and a second phase of nanoquasicrystalline aluminium-based material distributed therein and further including in said matrix fibrils of at least one other dissimilar material, said method comprising the steps of: selecting an aluminium-based alloy material for constituting said matrix; selecting said at least one other dissimilar material for constituting said fibril constituent; combining said matrix alloy and said at least one other dissimilar fibril material constituent together to form a base composite material billet; optionally deforming said base billet to convert said fibril material into reinforcing fibrils in said composite material.

In the case where the at least one material to form the fibrillar constituent is a ductile metal, that material may be incorporated as non-fibrillar particles at sizes greater than nano-dimensions. The optional deformation step would thus be employed in these circumstances to compact and deform the base billet to convert the incorporated material into the required fibrils.

In the case where, for example, the reinforcing fibrillar material is already in the form of nano-fibrils of carbon nanotubes, for example, the method of production may comprise incorporating the nanotubes into a base billet during a spray forming technique, for example, followed by a HIPing step, for example, to finally consolidate the base billet and from which parts may be produced by machining, for example. However, the optional deformation step is not precluded in the case of non-metallic fibrillar material.

The method also encompasses so-called “surface engineering” of the at least one fibril material in order to make the interface between the fibril material and the matrix metal compatible where necessary. Such surface engineering may be applied to particles which are to be subsequently deformed into fibrillar material or to material in fibrillar form when first combined with the matrix material.

The reinforcing fibrils in the final metal matrix composite material may preferably have a diameter of less than 1 μm as noted above.

The deformation of the base composite material billet may be carried out at temperatures which will largely depend upon the nature and composition of the base billet. For example, it may be acceptable to work above the recovery or recrystallisation temperature of the first phase of the matrix alloy, the nanostructured quasicrystalline phase content providing the strength retention of the matrix in the final composite material. Furthermore, the nanoquasicrystalline phase is likely to inhibit recrystallisation to a large extent even though the working temperature may be above that temperature where recrystallisation normally occurs. It may be necessary to work the base billet at a temperature sufficient to prevent excessive work hardening of the fibril material, the final objective being a good balance of properties between the matrix alloy and the fibril material to give the optimum properties in the final composite material.

There may be several suitable methods of combining the matrix aluminium-based alloy and metal fibril constituents together. Suitable methods are enumerated in the succeeding paragraphs.

A powder may be made of the aluminium-based alloy matrix material by, for example, making a melt of a desired composition and atomising said melt by a rapid solidification process (RSP) technique to form powder particles having a matrix comprising the desired first phase which may or may not be of nanocrystalline structure and the second phase of nanostructured quasicrystalline particles therein. The matrix powder and particles of the metal fibril constituent may then be mixed together in required proportions and compacted by a suitable technique such as hot isostatic pressing, for example, followed by mechanical working to reduce the cross sectional area of the base billet and extend and reduce the area of the metal fibril constituent in the composite material matrix. The mechanical working technique may include extrusion, swaging, drawing or rolling, for example. An important consideration is that the temperature of working should not exceed that temperature at which significant degradation of the nanostructured quasicrystalline phase begins to occur and/or undesirable reaction between fibril metal and aluminium begins to occur. Naturally, this working temperature will be dependent upon the composition and microstructural condition of the matrix alloy and the fibril nature.

An alternative production route according to the second aspect of the present invention may be a so-called spray casting route wherein a melt of the aluminium-based matrix alloy is prepared and spray cast onto a mould to create a billet. The fibril material constituent may be incorporated by injecting a stream of particles of the fibril material into the spray casting stream of the matrix material so that the former is simultaneously incorporated into the billet mould with the latter. The billet so formed is near to 100% density so that the billet can then be mechanically worked under the same provisos with regard to temperature as the powder route example described hereinabove.

Since spray casting does not generally produce a full 100% density it may be desirable to introduce a hot isostatic pressing step into the production process for material intended for critical applications.

Another production route may involve producing flakes directly from a melt or from a ribbon manufactured from a melt by an RSP melt spinning process, in the latter case, the flakes being obtained by crushing or chopping the ribbon, and subsequently compacting the flakes and fibril material together and treating as discussed above for powders.

The mechanical working processes applied to a compacted powder and/or to a spray cast base billet serve to achieve a fibril shape at nanoscale of the main reinforcement phase (the matrix second phase as defined hereinabove) and additionally to further reduce the crystal size of the matrix material thus increasing strength.

Because the aluminium-based alloys of the matrix may preferably possess the advantageous structure wherein the matrix second phase may have nanostructured quasicrystalline particles which retain their strengthening capability at temperatures up to at least 500° C. depending upon the alloy chemical composition, it is possible to produce the matrix alloy by an RSP route, for example, as a powder by an atomisation process, a ribbon or flakes by melt spinning or a billet by spray casting all as described hereinabove and, to work the material so produced without degrading the strengthening phase therein. For example, if a powder is produced that possesses the structure mentioned above it may be compacted and mechanically worked at relatively elevated temperatures for an aluminium-based alloy without degrading the microstructure. However, the ability to work the base billet of the composite material towards the desired microstructure at relatively elevated temperatures without degrading the microstructure provides benefits in lower compacting and/or extrusion pressures, improved cohesion and higher density which result in high strength and toughness of the resulting material.

The fibril material may be incorporated into the base billet actually in the form of fibres or elongate particles which may then be reduced in cross sectional area by subsequent mechanical working.

### BRIEF DESCRIPTION OF THE DRAWINGS

In order that the present invention may be more fully understood, an example will now be described with reference to the accompanying drawing which shows a schematic flow diagram of a production route according to one embodiment of the second aspect of the invention for preparing a metal composite material according to the first aspect.

### DETAILED DESCRIPTION

The drawing shows a schematic representation of a production process 10 involving spray casting of the constituents of a metal composite material according to the present invention.

A melt 12 of an aluminium-based matrix alloy having a composition comprising Al—Fe—Cr—Nb is prepared in an induction furnace having a protective inert atmosphere such as argon or nitrogen, for example. A source of titanium particles 14 for injection is prepared. The melt 12 is spray cast 16 and the titanium particles 14 are injected 18 into the sprayed stream simultaneously onto a mould 20 to form a base composite billet 22. The base billet 22 so formed is then hot isostatically pressed (HIPed) or extruded 24 in order to increase the density, and then deformed such as by rolling 26, for example, to form a wrought feedstock material 28, wherein the titanium particles are in the form of reinforcing fibres, and from which material finished articles 32 may be machined 30.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A metal matrix composite material, the material comprising:
an aluminum-based alloy matrix, the matrix comprising a microstructure composed of at least a first aluminum alloy phase and having a second phase of nanostructured quasicrystalline particles embedded therein; and
further including in said matrix fibrils of at least one other dissimilar material.

2.-26. (canceled)

27. The metal matrix composite material according to claim 1, wherein said nanostructured quasicrystalline particles predominantly have a size of less than about 1 μm.

28. The metal matrix composite material according to claim 1, wherein the second phase of the nanostructured quasicrystalline particles in the aluminum-based alloy matrix is in the form of icosahedral particles distributed throughout the aluminum-based alloy matrix.

29. The metal matrix composite material according to claim 1, wherein the aluminum-based alloy matrix is selected from one the group comprising: Al—Fe; Al—Ni; Al—Mn; Al—Cr; Al—V; Al—V—Ni; Al—Ni—Co; Al—Cu—Fe; Al—Fe—V; Al—Fe—Ti; Al—Fe—Mn; Al—Mn—Co; Al—Mn—Ni; one of Al—Mn—Ce and MM; one of Al—Cr—Ce and MM; Al—Cu—Fe—Cr; Al—Fe—Nb; Al—Fe—Ce; Al—Fe—Cr; and Al—Fe—Cr—X; and
wherein X is one or more elements selected from the group comprising Si, Ce, Ti, V, Nb and Ta, and MM is mischmetal, a mixture of rare earth elements.

30. The metal matrix composite material according to claim 29, wherein the aluminum-based alloy matrix material is Al—Fe—Cr—X and the aluminum content lies in the range from 88 to 96 at % and wherein the X component may be selected from one or more of titanium, vanadium, niobium, tantalum and silicon, and does not exceed 4 at % in total.

31. The metal matrix composite material according claim 30, wherein the X element does not exceed 3 at % in total.

32. The metal matrix composite material according to claim 31, wherein the aluminium content lies in the range from 90 to 95 at %.

33. The metal matrix composite material according to claim 31 wherein the matrix material has a nominal composition in at % comprising Al93-Fe3-Cr2-X2.

34. The metal matrix composite material according to claim 30, wherein the X element is niobium.

35. The metal matrix composite according to claim 30, wherein the X element is tantalum.

36. The metal matrix composite according to claim 30, wherein the iron content is greater than the chromium content.

37. The metal matrix composite according to claim 1, wherein the fibrillar constituent comprises at least one of metallic and non-metallic materials.

38. The metal matrix composite material according to claim 1, wherein the fibrillar constituent comprises at least one of a ductile metal and an alloy.

39. The metal matrix composite material according to claim 38, wherein the fibrillar constituent is selected from at least one of the group comprising: nickel, molybdenum, titanium, niobium, tantalum, vanadium and chromium and alloys thereof.

40. The metal matrix composite material according to claim 1, wherein the fibrillar material is selected from the group comprising: carbon nanotubes and nanofibrils, boron nitride fibres, tubes and whiskers.

41. The metal matrix composite material according to claim 1, wherein the content of fibrillar material lies in the range from about 5 to about 50 volume %.

42. The metal matrix composite material according to claim 1, wherein the fibril constituent is in the form of one of fibrils and tubes wherein the diameter of the selected one of the fibrils and tubes is less than about 1 μm.

43. A method for the manufacture of a metal matrix composite material, the material comprising an aluminium-based alloy matrix comprising a microstructure having at least a first phase of aluminium-based alloy material and a second phase of nanoquasicrystalline aluminium-based material distributed therein and further including in said aluminium-based alloy matrix fibrils of at least one other dissimilar material that is a fibrillar constituent, said method comprising the steps of:
selecting an aluminium-based alloy material for constituting said aluminium-based alloy matrix;
selecting at least one dissimilar material for constituting said fibril constituent;
combining said matrix alloy and said at least one dissimilar fibril material constituent together to form a base composite material billet; and
optionally deforming said base billet to convert said fibril material into reinforcing fibrils in said composite material.

44. The method according to claim 43, wherein the fibril material is one of a metal and an alloy and is incorporated into said base billet in particulate form.

45. The method according to claim 44, wherein said particulate material is converted to fibrillar form in said composite material by said optional deformation step.

46. The method according to claim 43, wherein the fibril material is in fibril form when combined with said matrix material.

47. The method according to claim 43, wherein said base billet is formed by a particulates compaction route.

48. The method according to claim 43, wherein said at least one other fibril material is combined into said base billet by a metal spraying route.

49. The method according to claim 43, wherein said at least one other dissimilar fibril material is treated in order to make an interface between the fibril material and the matrix metal compatible.
